(19) United States
(12) Patent Application Publication
(10) Pub. No.: US 2013/0186876 A1
(43) Pub. Date: Jul. 25, 2013

(54) GRILL

(71) Applicant: Hudson WANG, Kaohsiung City (TW)

(72) Inventor: Hudson WANG, Kaohsiung City (TW)

(21) Appl. No.: 13/355,952

(22) Filed: Jan. 23, 2012

(51) Int. Cl. H05B 1/00; F27D 11/04

(52) U.S. Cl. 219/385

(57) ABSTRACT

A grill includes upper and lower plates and heat conducting members. The upper plate includes alternating ridge and furrow portions, and is formed with alternating receiving spaces and first connecting surfaces. The heat conducting members are disposed in the receiving spaces, respectively. The first connecting surfaces are provided at the respective furrow portions. The lower plate includes alternating and interconnected first and second plate portions. The first plate portions respectively correspond to the ridge portions . The second plate portions have second connecting surfaces and second holes registered with first holes formed in the furrow portions. The furrow portions are welded to the second plate portions with the first and second connecting surfaces being in intimate contact.

### BACKGROUND OF THE INVENTION

1. Field of the Invention

This invention relates to a cooking device, more particularly to a grill.

2. Description of the Related Art

Referring to FIG. 1, a conventional grill 11 is usually made of cast iron covered with porcelain coating. However, porcelain coating may peel off easily thus affecting adversely the service life and appearance of the conventional grill 11. The conventional grill may also be made of SUS304 or SUS430 stainless steel, the manufacturing cost of which is, however, relatively high.

Referring to FIGS. 2 and 3, to overcome the above drawbacks, there is another type of conventional grill 14 comprising a plurality of stainless steel tubes 12 that are inserted with iron materials. However, in order to avoid rusting of the iron materials 13, it is necessary to seal opposite ends of each of the stainless steel tubes 12 by welding. Due to the relatively small size of the stainless steel tubes 12, the welding process is rather troublesome. Further, to weld individual stainless steel tubes 12 into grid form is also rather difficult, resulting in a relatively low yield rate when manufacturing the conventional grill 14.

### SUMMARY OF THE INVENTION

Therefore, the object of the present invention is to provide a grill capable of alleviating the above mentioned drawbacks of the prior art.

According to this invention, a grill comprises an upper plate having a corrugated cross-section along a first direction, a plurality of heat conducting members, and a lower plate. The upper plate includes a plurality of alternating ridge portions and furrow portions, and has a bottom side formed with a plurality of alternating receiving spaces and first connecting surfaces. Each of the receiving spaces is defined by a respective one of the ridge portions. Each of the first connecting surfaces is provided at a respective one of the furrow portions. Each of the furrow portions is formed therethrough with a plurality of spaced-apart first through holes. Each of the heat conducting members is disposed in a corresponding one of the receiving spaces. The lower plate includes a plurality of alternating and interconnected first plate portions and second plate portions. The first plate portions are respectively disposed to correspond with the ridge portions, and the second plate portions have second connecting surfaces respectively disposed to confront the first connecting surfaces. Each of the second plate portions is formed therethrough with a plurality of spaced-apart second through holes. The furrow portions are welded to the second plate portions with the first connecting surfaces contacting intimately and respectively the second connecting surfaces, with the receiving spaces being closed by the first plate portions whilst the heat conducting members are respectively disposed therein, and with the first through holes respectively registered with the second through holes in the second plate portions of the lower plate.

### BRIEF DESCRIPTION OF THE DRAWINGS

Other features and advantages of the pre sent invention will become apparent in the following detailed description of the preferred embodiment of the invention, with reference to the accompanying drawings, in which:

FIG. 1 is a perspective view of a conventional grill;

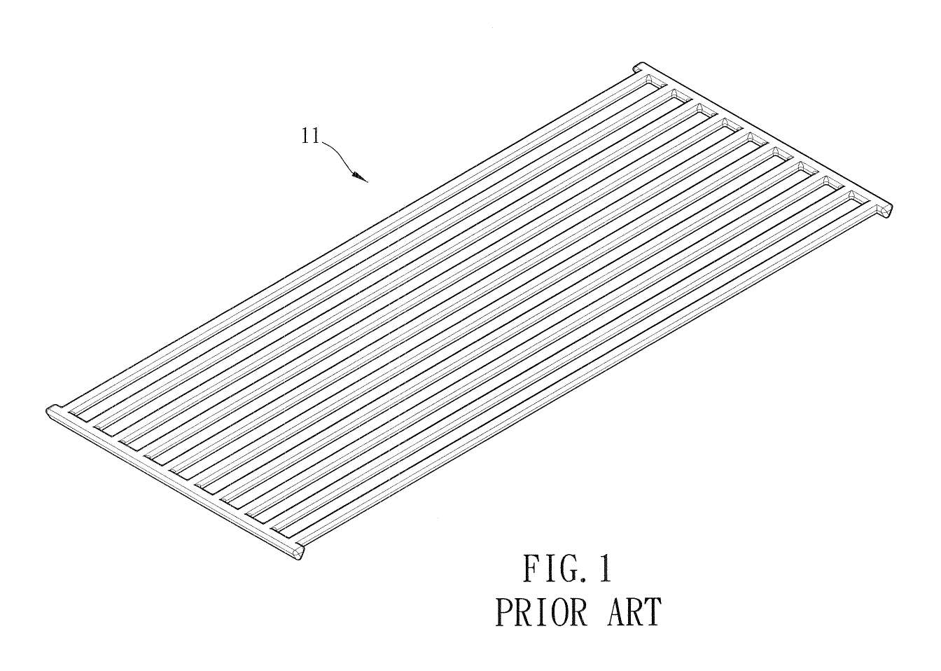

FIG. 2 is a perspective view of another conventional grill;

FIG. 3 is a schematic sectional view of the conventional grill of FIG. 2, illustrating stainless steel tubes inserted with iron materials;

FIG. 4 is an exploded perspective view of a preferred embodiment of a grill according to the present invention;

FIG. 5 is a sectional view of the preferred embodiment; and

FIG. 6 is a schematic sectional view of the preferred embodiment taken along line VI-VI in FIG. 4, illustrating the grill being disposed on a stove for grilling foods disposed thereon,

### DETAILED DESCRIPTION OF THE PREFERRED EMBODIMENT

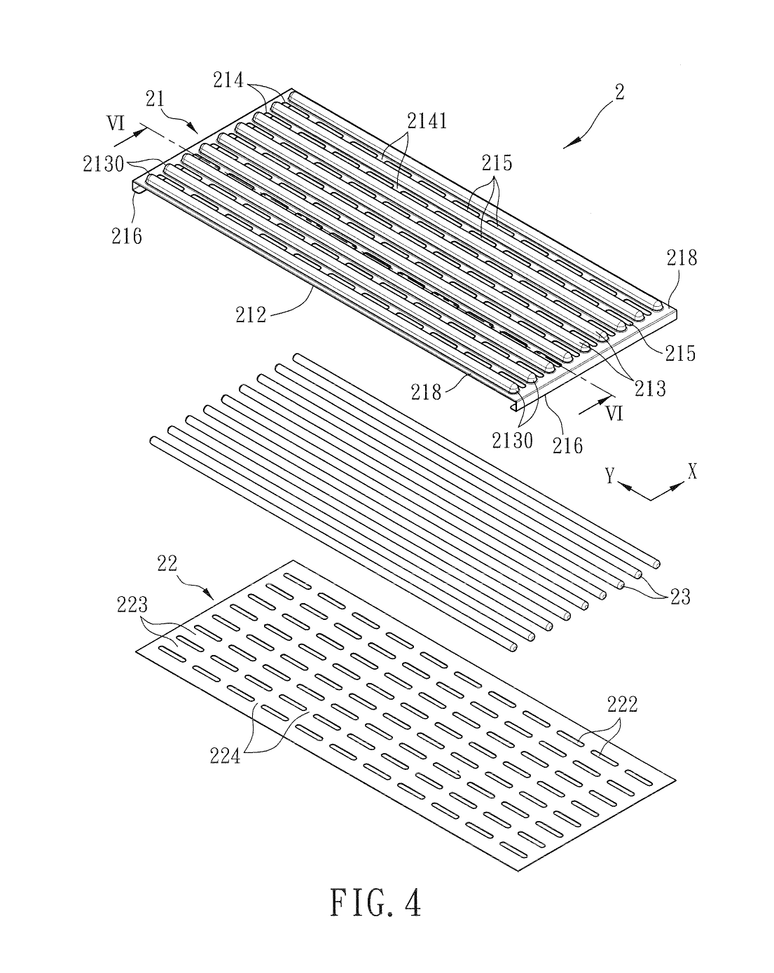

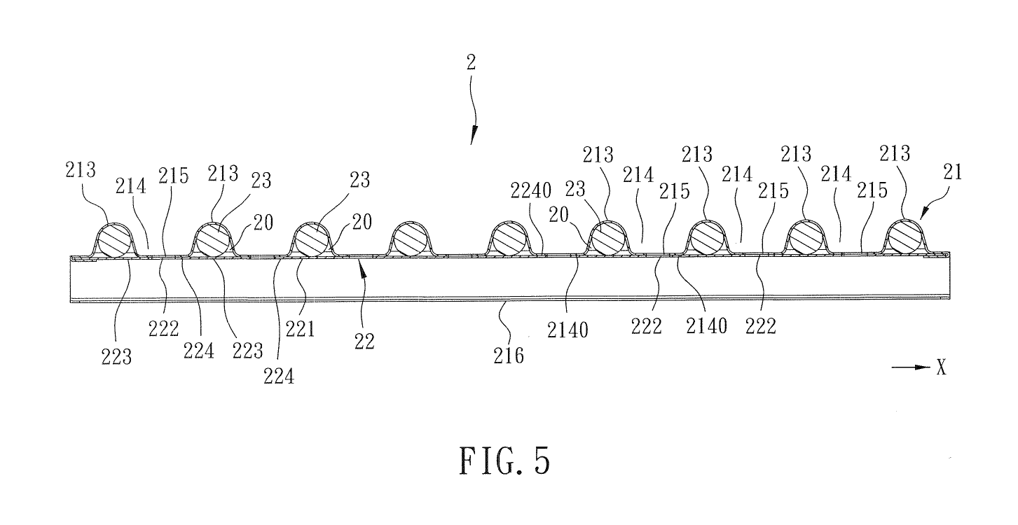

Referring to FIGS. 4 and 5, the preferred embodiment of the grill 2 according to the present invention comprises an upper plate 21, a lower plate 22, and a plurality of heat conducting members 23. Each of the upper plate 21 and the lower plate 22 is made from a stainless steel material, and each of the heat conducting members 23 is an elongated iron material.

The upper plate 21 has a corrugated cross-section along a first direction (X) and includes a plurality of alternating ridge portions 213 and furrow portions 214 extending in a second direction (Y) transverse to the first direction (X).

The upper plate 21 has a bottom side 212 formed with a plurality of alternating receiving spaces 20 and first connecting surfaces 2140. Each of the receiving spaces 20 is defined by a respective one of the ridge portions 213. Each of the ridge portions 213 is formed integrally with two end wall parts 2130 opposite to each other in the second direction (Y) and respectively closing two ends of the respective receiving space 20. Each of the heat conducting members 23 is disposed in a corresponding one of the receiving spaces 20.

Each of the first connecting surfaces 2140 of the upper plate 21 is provided at a respective one of the furrow portions 214. Each of the furrow portions 214 is formed therethrough with a plurality of spaced-apart first through holes 215.

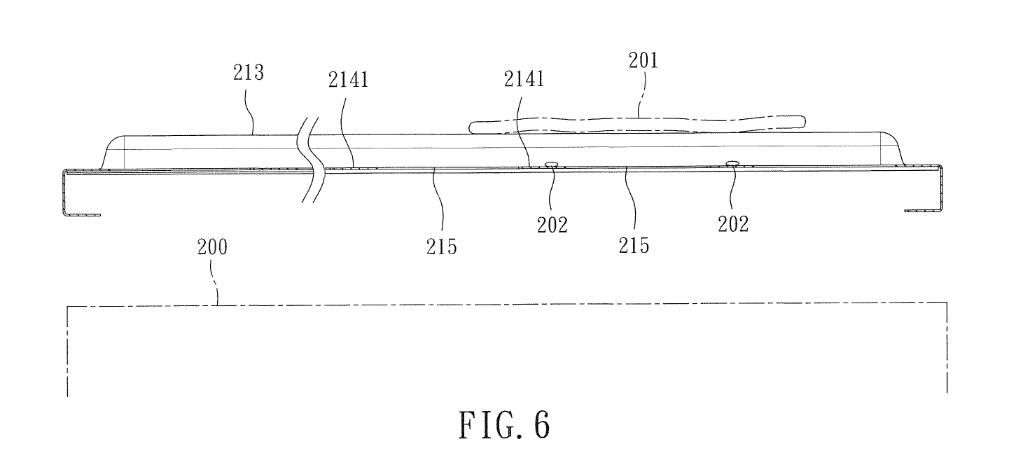

Further referring to FIG. 6, each of the furrow portions 214 includes a plurality of blocking parts 2141. Each of the blocking parts 2141 is disposed between a corresponding adjacent pair of the first through holes 215 for blocking liquid flow, e.g. juice or oil of the food 201, therethrough, and preventing the same from dropping onto a stove 200 on which the grill 2 is disposed. Additionally, each of the ridge portions 213 forms a smooth round junction with an adjacent one of the furrow portions 214.

The lower plate 22 includes a plurality of alternating and interconnected first plate portions 223 and second plate portions 224. The first plate portions 223 are respectively disposed to correspond with the ridge portions 213 of the upper plate 21. The second plate portions 224 have second connecting surfaces 2240 respectively disposed to confront the first connecting surfaces 2140 of the upper plate 21. Each of the second plate portions 224 is formed therethrough with a plurality of spaced-apart second through holes 222.

The furrow portions 214 of the upper plate 21 are welded to the second plate portions 224 of the lower plate 22 with the first connecting surfaces 2140 contacting intimately and respectively the second connecting surfaces 2240, with the receiving spaces 20 being closed by the first plate portions 223 of the lower plate 22 whilst the heat conducting members 23 are respectively disposed therein, and with the first through holes 215 respectively registered with the second through holes 222 in the second plate portions 224 of the lower plate 22.

In this embodiment, the upper plate 21 includes a plate body 218 with two opposite edges, and two engaging portions 216 that extend respectively from the two opposite edges of the plate body 218 and that are bent toward each other for clamping the lower plate 22 against the plate body 218. The ridge and furrow portions 213, 214 are formed on the plate body 218. It is noted that the engaging portions may be provided on the lower plate 22 for clamping the upper plate 21 in other embodiments of this invention.

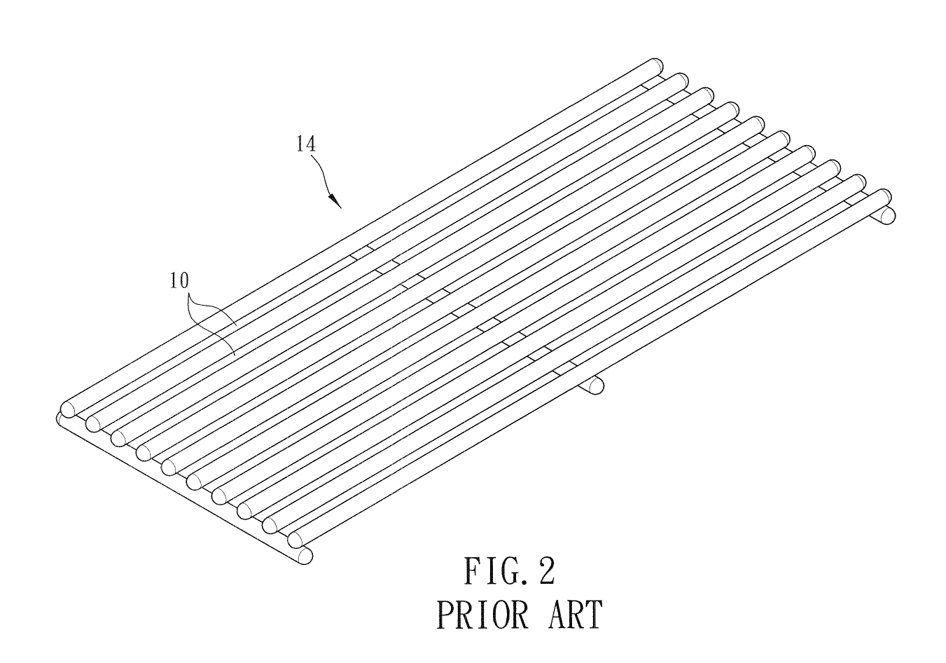

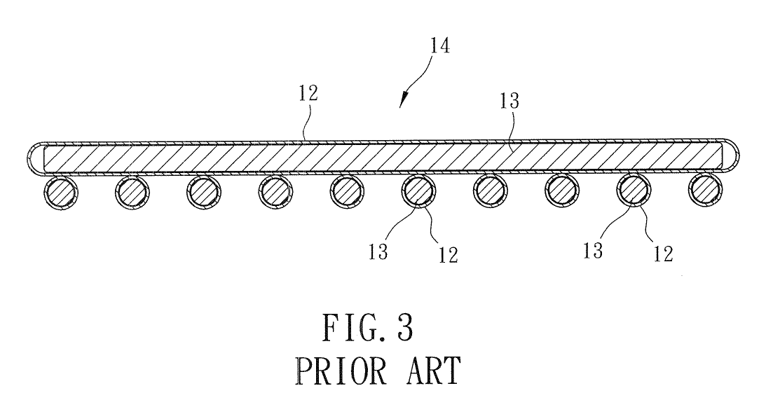

To sum up, the advantages of the grill 2 of the present invention are as follows. In the present invention, the heat conducting members 23 are disposed in the respective receiving spaces 20 that are closed by the end wall parts 2130 of the ridge portions 213 of the upper plate 21 and that are sealed by the first plate portions 223 of the lower plate 22, thereby eliminating the need to seal opposite ends of the stainless steel tubes 12 in the prior art. Further, contact areas between the first and second connecting surfaces 2140, 2240 are relatively large, making it relatively simple to weld the upper plate 21 to the lower plate as compared to welding individual stainless steel tubes 12 of the conventional grill 14 illustrated in FIGS. 2 and 3. Additionally, the configuration of the smooth round junction between the ridge portions 213 and the respective adjacent furrow portions 214 makes the grill 2 of the present invention easy to clean. Finally, liquid 202, i.e., juice or oil of food 201, can be retained in the blocking parts 2141 of the furrow portions 214 of the upper plate 21, such that the amount of the liquid 202 that flows through the first and second through holes 215,222 and drops on the stove 200 can be decreased.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A grill comprising:
an upper plate having a corrugated cross-section along a first direction, said upper plate including a plurality of alternating ridge portions and furrow portions, said upper plate having a bottom side formed with a plurality of alternating receiving spaces and first connecting surfaces, each of said receiving spaces being defined by a respective one of said ridge portions, each of said first connecting surfaces being provided at a respective one of said furrow portions, each of said furrow portions being formed therethrough with a plurality of spaced-apart first through holes;
a plurality of heat conducting members, each disposed in a corresponding one of said receiving spaces; and
a lower plate including a plurality of alternating and interconnected first plate portions and second plate portions, said first plate portions being respectively disposed to correspond with said ridge portions, said second plate portions having second connecting surfaces respectively disposed to confront said first connecting surfaces, each of said second plate portions being formed therethrough with a plurality of spaced-apart second through holes, said furrow portions being welded to said second plate portions with said first connecting surfaces contacting intimately and respectively said second connecting surfaces, with said receiving spaces being closed by said first plate portions whilst said heat conducting members are respectively disposed therein, and with said first through hole s respectively registered with said second through holes in said second plate portions of said lower plate.

2. The grill as claimed in claim 1, wherein said furrow and ridge portions of said upper plate extend in a second direction transverse to the first direction.

3. The grill as claimed in claim 2, wherein each of said ridge portions is formed integrally with two end wall parts opposite to each other in the second direction and respectively closing two ends of the respective one of said receiving spaces.

4. The grill as claimed in claim 1, wherein one of said upper and lower plates includes a plate body with two opposite edges, and two engaging portions extending respectively from said two opposite edges of said plate body.

5. The grill as claimed in claim 4, wherein said engaging portions are bent toward each other for clamping the other of said upper and lower plates against said plate body.

6. The grill as claimed in claim 5, wherein said upper plate includes said plate body and said engaging portions.

7. The grill as claimed in claim 1, wherein each of said upper plate and said lower plate is made from a stainless steel material, and each of said heat conducting members is an elongated iron material received in the respective one of said receiving spaces.

8. The grill as claimed in claim 1, wherein each of said furrow portions further includes a plurality of blocking parts, each of which is disposed between a corresponding adjacent pair of said first through holes for blocking liquid flow therethrough.

9. The grill as claimed in claim 1, wherein each of said ridge portions forms a smooth round junction with an adjacent one of said furrow portions.
